(19) United States
(12) Patent Application Publication
(10) Pub. No.: US 2021/0129763 A1
(43) Pub. Date: May 6, 2021

(54) FOLDABLE EQUIPMENT RACK

(71) Applicant: Kuat Innovations, LLC, Springfield, MO (US)

(72) Inventors: Josh Schwartz, Springfield, MO (US); Luke Kuschmeader, Springfield, MO (US); Jordan Bowles, Springfield, MO (US)

(21) Appl. No.: 16/672,453

(22) Filed: Nov. 2, 2019

(51) Int. Cl. B60R 9/048; B60R 9/058

(52) U.S. Cl. CPC B60R 9/048; B60R 9/12; B60R 9/058

(57) ABSTRACT

The equipment rack for attaching equipment to the roof of a vehicle includes a rack assembly that may be folded from a stowed position to an operational position. The rack assembly is attached to the vehicle by a hinge and a positional latch mechanism to selectively retain the rack assembly in the stowed position or the operational position. The user of the rack may selectively pivot the rack assembly from one position to another. The pivotal latch mechanism may retain the rack assembly in one, two, or more desired positions. Some versions of the latch mechanism utilize a shuttle member in one element that engages a socket in the other element. Other versions of the latch mechanism utilize surfaces on the rack assembly and the hinge interact to retain the rack assembly at desired positions.

### CROSS-REFERENCE TO RELATED APPLICATIONS

None.

### BACKGROUND

### Field of the Invention

This disclosure is in the field of equipment racks for carrying equipment on vehicles. More specifically, this disclosure is in the field of externally mounted equipment racks for use on a vehicle to temporarily carry equipment such as skis, snowboards, kayaks, or other types of equipment.

### Description of the Related Art

Various designs for externally mounted equipment racks have been used to carry skis, snowboards, and other similar types of equipment on a vehicle to transport the equipment from place to place. Such racks are typically externally mounted on the vehicle in a semi-permanent manner, such that they may be removed when not in use, but are often left on the vehicle between uses of the rack to carry equipment. Since these racks are externally mounted on the vehicle they contribute to wind drag that reduces fuel efficiency as well as wind noise that may be a nuisance to occupants of the vehicle. The wind pressure may also cause additional wear and tear on the equipment racks when they are not in use, thus reducing the useful life of the equipment rack.

The alternative of removing the equipment rack from the vehicle between each use is unacceptable because the equipment racks are typically attached to the vehicle in a manner that may require tools or an unacceptable amount of additional time to remove the equipment racks, and to reinstall the equipment racks.

It is desired to have an externally mounted equipment rack that may be quickly reconfigured when not in use to carry equipment. The reconfiguration would preferably reduce wear and tear on the rack from wind pressure or road hazards, reduce wind noise, and avoid some of the negative impacts on fuel efficiency. The rack described herein provides for reconfiguration from a stowed position with lower profile to an operational position where it may securely hold equipment, and vice versa.

### SUMMARY OF THE INVENTION

In various embodiments, the equipment rack includes a rack assembly, a hinge pivotally attaching the rack assembly to a vehicle. The rack assembly is configured to pivot with respect to the hinge from a stowed position to an operational position. A positional latch mechanism selectively retains the rack assembly in the stowed position or the operational position. The positional latch mechanism may be actuated to release the rack assembly from the stowed position.

In some versions the positional latch mechanism is a first feature attached to the rack assembly that selectively engages a second feature attached to the hinge. In some of these embodiments, one of the features is a shuttle member slidably attached to the rack assembly or the hinge. In these versions the other feature is a socket capable of receiving the shuttle member. In these embodiments, the rack assembly cannot pivot with respect to the hinge when the shuttle member is disposed in the socket.

In some embodiments of the rack, the socket has a cross-sectional shape that receives the shuttle member at a pivotal position corresponding to the stored position of the rack assembly. In these and other embodiments, the socket has a cross-sectional shape that receives the shuttle member at a pivotal position corresponding to the operational position of the rack assembly.

In some embodiments, a portion of the shuttle member has a non-circular cross-sectional shape, and a portion of the socket has a cross-sectional shape capable of receiving the non-circular portion of the shuttle member, wherein when the portion of the shuttle member is received by the non-circular portion of the socket the shuttle member is pivotally fixed with respect to the hinge. In these embodiments, when the non-circular portion of the shuttle member is withdrawn from the non-circular portion of the socket then the shuttle member may pivot with respect to the hinge. In some versions of the equipment rack the cross-sectional shape of the socket is congruent to the cross-sectional shape of the shuttle member. In other versions of the equipment rack the socket is capable of receiving the shuttle member at a plurality of pivotal positions.

In some embodiments of the equipment rack the positional latch mechanism includes a biasing mechanism to urge the shuttle member into the socket of the hinge. Similarly other embodiments include an actuator to withdraw the shuttle member from the socket of the hinge.

In other embodiments of the equipment rack the first feature attached to the rack assembly comprises a first surface, and the second feature attached to the hinge assembly comprises a second surface attached to the hinge, wherein the first surface interacts with the second surface to resist rotation of the rack assembly from the stowed position or the operational position. In some of these embodiments the rack assembly pivots from the stowed position to the operational position when the interaction of the first surface with the second surface is overcome by a rotational force applied to the rack assembly. In some embodiments of the equipment rack the applied rotational force causes elastic deformation of the first surface or the second surface to pivot the rack assembly from one desired position to another desired position. In other embodiments of the equipment rack the applied rotational force overcomes frictional resistance to pivot the rack assembly from one desired position to another desired position.

Some of these versions of the equipment rack have a third surface attached to the hinge, wherein the third surface interacts with the first surface to resist rotation of the rack assembly from a desired pivotal position of the rack assembly. In some embodiments of the equipment rack the first surface, the second surface, and the third surface are substantially tangential to the pivotal axis of the rack assembly and the hinge.

### BRIEF DESCRIPTION OF THE DRAWINGS

FIG. 1A is a perspective view of embodiments of the equipment rack installed on the roof of a vehicle in use to hold equipment.

FIG. 1B is a perspective view of embodiments of the equipment rack installed on the roof of a vehicle and placed in a stowed position.

FIG. 1C is a perspective view of an embodiment of the equipment rack in a stowed position.

FIG. 1D is a perspective view of an embodiment of the equipment rack in an operational position.

FIG. 1E is an end plan view of an embodiment of the equipment rack in a stowed position.

FIG. 2A is a perspective view of an embodiment of the positional latch mechanism of the equipment rack in a stowed and latched position.

FIG. 2B is a cross-sectional view of an embodiment of the positional latch mechanism of the equipment rack in a stowed and latched position.

FIG. 2C is a cut-away view of an embodiment of the positional latch mechanism of the equipment rack in a stowed and latched position.

FIG. 2D is a cross-sectional view of an embodiment of the positional latch mechanism of the equipment rack in a stowed and latched position.

FIG. 3A is a perspective view of an embodiment of the positional latch mechanism of the equipment rack in a stowed and unlatched position.

FIG. 3B is a cross-sectional view of an embodiment of the positional latch mechanism of the equipment rack in a stowed and unlatched position.

FIG. 3C is a cut-away view of an embodiment of the positional latch mechanism of the equipment rack in a stowed and unlatched position.

FIG. 3D is a cross-sectional view of an embodiment of the positional latch mechanism of the equipment rack in a stowed and unlatched position.

FIG. 4A is a perspective view of an embodiment of the positional latch mechanism of the equipment rack in a partially pivoted and unlatched position.

FIG. 4B is a cross-sectional view of an embodiment of the positional latch mechanism of the equipment rack in a partially pivoted and unlatched position.

FIG. 4C is a cut-away view of an embodiment of the positional latch mechanism of the equipment rack in a partially pivoted and unlatched position.

FIG. 4B is a cross-sectional view of an embodiment of the positional latch mechanism of the equipment rack in a partially pivoted and unlatched position.

FIG. 5A is a perspective view of an embodiment of the positional latch mechanism of the equipment rack in an operational and latched position.

FIG. 5B is a cross-sectional view of an embodiment of the positional latch mechanism of the equipment rack in an operational and latched position.

FIG. 5C is a cut-away view of an embodiment of the positional latch mechanism of the equipment rack in an operational and latched position.

FIG. 5D is a cut-away view of an embodiment of the positional latch mechanism of the equipment rack in an operational and latched position.

FIG. 6 is an exploded view of an embodiment of the positional latch mechanism.

FIG. 7A is a perspective view of an additional embodiment of the folding rack with the positional latch system.

FIG. 7B is a top view of an additional embodiment of the folding rack with the positional latch system.

FIG. 7C is a perspective view of an additional embodiment of the folding rack with the positional latch system.

FIG. 7D is a perspective view of an additional embodiment of the folding rack with the positional latch system.

FIG. 7E is a cross-sectional view of an additional embodiment of the positional latch system.

FIG. 7F is a cross-sectional view of an additional embodiment of the positional latch system.

FIG. 7G is a detail perspective view of an additional embodiment of the positional latch system.

### DETAILED DESCRIPTION

The inventive rack disclosed herein is capable of pivoting from an operational position to a stowed position, and vice versa. The exemplary rack is a type that may be used to securely carry skis or a snowboard on the exterior of a vehicle. The inventive rack may also be used for other types of equipment such as racks for kayaks, surfboards, and other similar equipment. In some embodiments a positional latch mechanism is used to secure the device in a desired position, such as the operational position, a stowed position, or any other relative positions, and to prevent unintentional movement of the rack assembly 100 from that desired position. The positional latch mechanism is provided with a means for actuating, releasing, disengaging, or otherwise freeing the latch mechanism so that the rack assembly 100 may be repositioned from one desired position to another. The positional latch mechanism may also be provided with a mechanism for reengaging the positional latch mechanism once the rack assembly 100 is repositioned as desired. The positional latch mechanism is formed from various features attached or connected to a hinge and to the rack assembly, including the described embodiments depicted in the figures as well as other embodiments that are within the scope of the claims.

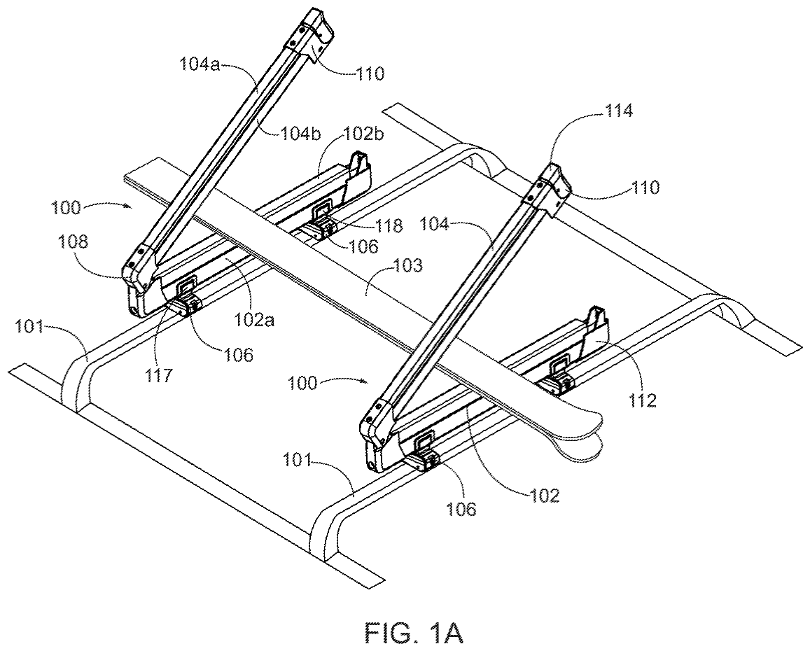

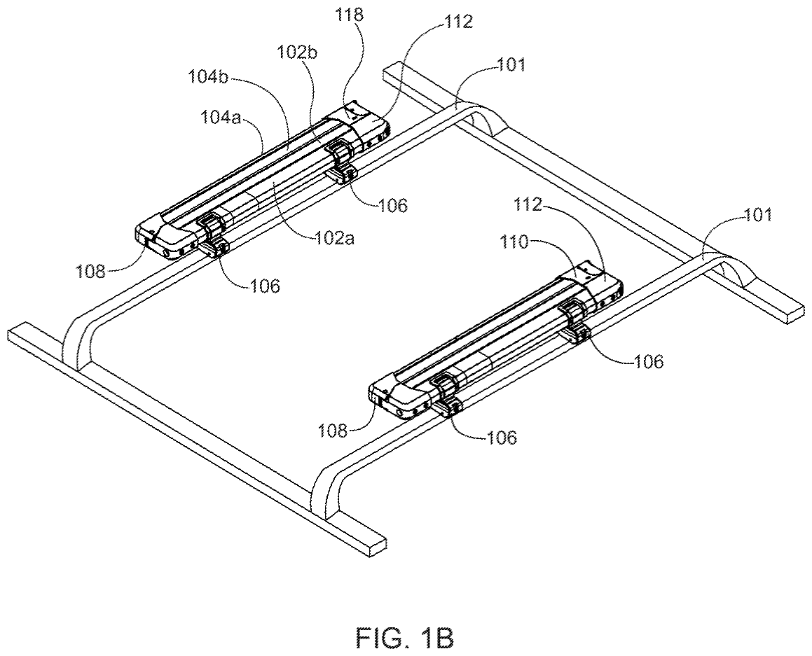

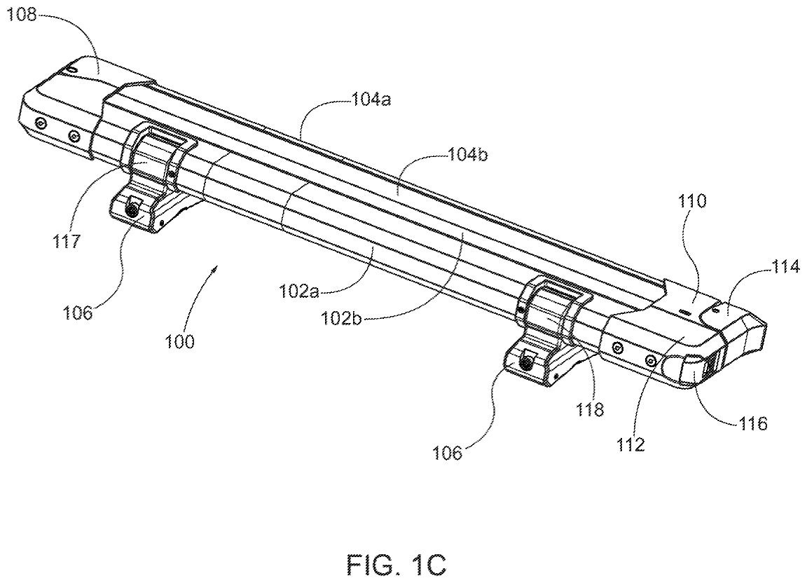

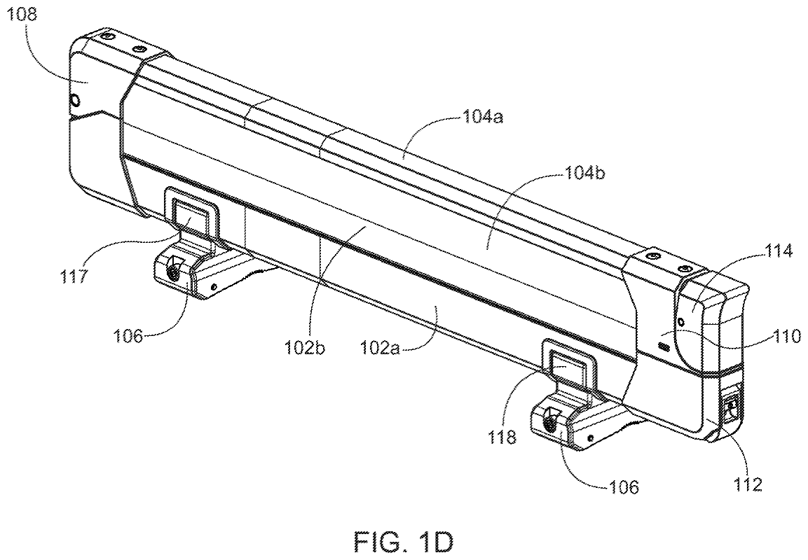

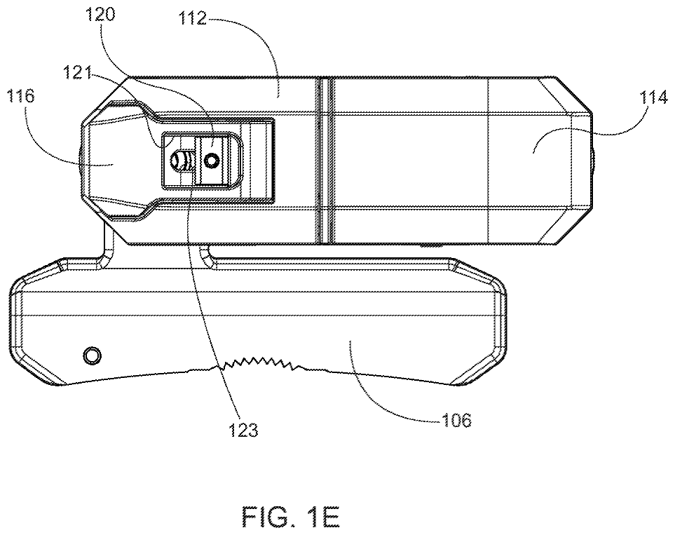

An embodiment of a rack assembly 100 with the positional latch mechanism is depicted in the figures. Referring now to FIG. 1A, a roof rack on a vehicle is depicted with crossbars 101. Two rack assemblies 100 are installed on the vehicle to support the skis 103. The rack assembly 100 comprises a base member 102 that provides support to the equipment carried on the rack assembly 100. In some embodiments the base 102 comprises a rigid or semi-rigid structural member 102a and a support member 102b that provides cushion, provides a sufficient coefficient of friction to grip the equipment, and prevents scratches and similar damage to the equipment. The depicted rack assembly 100 further comprises a clamp member 104 that secures the equipment on rack assembly 100 by sandwiching it between the two members 102 and 104. The clamp member 104 may also comprise a rigid or semi-rigid structural member 104a and a support member 104b that cushions or supports the equipment when it is secured between the base and clamp members.

The two members 102 and 104 may be joined at one end by a hinge 108 that allows the clamp member 104 to be lifted away from base member 102 so that equipment may be placed on the rack assembly 100 or removed from the rack assembly 100. The other end of members 102 and 104 may be connected by a clamp mechanism. In the depicted embodiment, the clamp mechanism comprises a clamp latch 110 attached to the clamp member 104, and a base latch 112 attached to the base member 102. The clamp latch 110 and base latch 112 releasably engage to hold the clamp mechanism closed when equipment is held on the rack assembly 100 or when the rack assembly 100 is not in use. An actuator such as clamp release 114 is provided so that the user may release the clamp mechanism, raise member 104, and place or retrieve equipment on or from the rack assembly 100.

As depicted in FIG. 1B, when the rack assemblies 100 are not in use holding equipment such as skis 103 they may be reconfigured to a stowed position. In this position, the rack assemblies 100 present much less forward-facing area to the wind as the vehicle travels, and thus create less wind resistance, turbulence, and reduce wind noise. The rack assemblies 100 may also be less prone to damage from road debris and other hazards in the stowed position. In some embodiments, with the base member 102 presenting its rigid or semi-rigid surface to the wind, and in close proximity to the points of attachment to crossbars 101, the wind force on the rack assembly 100 may create less stress on the component parts of the rack assembly 100. The depicted embodiment has a stowed position for the rack assembly that has been pivoted from the operational position approximately 90 degrees away from the forward direction of travel for the vehicle. In other embodiments, the stowed position may be pivoted in another direction or by a different degree of rotation. For example the latch mechanism may be able to secure the rack assembly in desired positions that are at any desired pivotal angle from the operational position.

FIG. 1C provides a more detailed depiction of an embodiment of the rack assembly 100 in a stowed position. The rack assembly 100 attaches to the vehicle via mount 106. The specific type of mount 106 is not limiting to the scope of the invention. The mount 106 may utilize a strap or adjustable device to attach to a vehicle or may be designed to directly connect to some type of roof rack or other attachment system. The base member 102 is pivotally attached to the mounts 106 so that the base member 102 and clamp member 102 can both pivot to the stowed position without removing or disconnecting the mounts 106 from the vehicle or structure to which they are attached. In this embodiment, one roof mount 106 is attached to or formed unitarily with a hinge 117, and the other roof mount 106 is attached to or formed unitarily with a hinge 118.

The positional latch mechanism allows a user to quickly engage and disengage a latch that will securely hold the rack assembly 100 in one or more desired positions, such as the stowed or operational positions of the depicted rack assembly 100. In the depicted embodiment of the rack assembly 100, the positional latch mechanism is disposed inside one end of member 102 and is actuated by a lever 116 disposed near the base latch 112. The joint between the base member 102 and the mount 106 is a knuckle-type hinge, with the eye 118 inserting into the fork 119. Components 118 and 119 may also be considered the barrels of a barrel hinge, with the length of the central barrel 118 somewhat longer than the outer barrels 119. Other hinge types or relative component sizes may be used in various embodiments of the rack assembly 100.

The operational position is depicted in FIG. 1D, which clearly shows the much greater forward-facing area of the rack assembly 100 in this position. This leads to greatly increased stresses on the mounts 106, hinges 117 and 118, as well as other components of the rack assemblies 100 and the vehicle to which they are attached. FIG. 1E depicts an end view of an embodiment of the rack assembly 100. The lever 116 is shown in a closed position, with sliding nut 120 visible in the groove in lever 116.

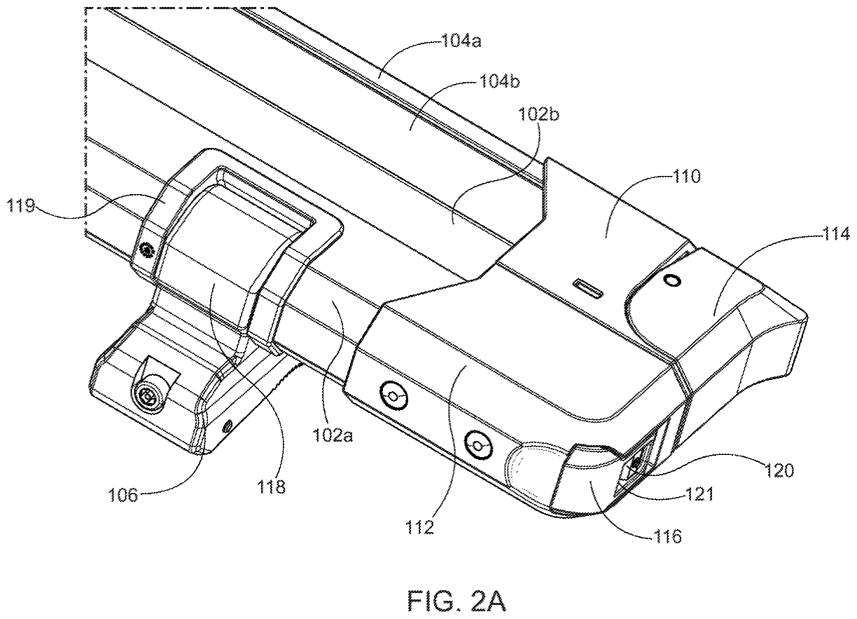

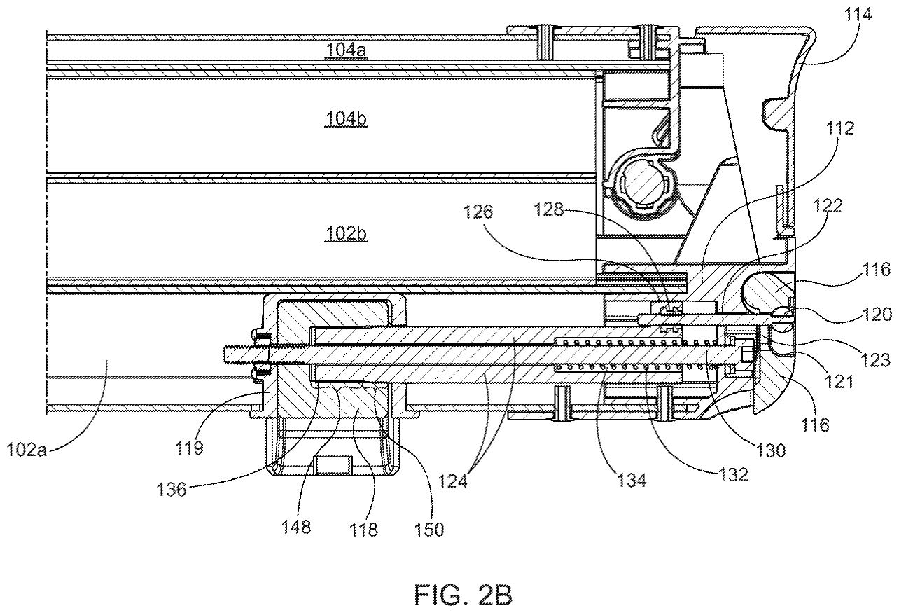

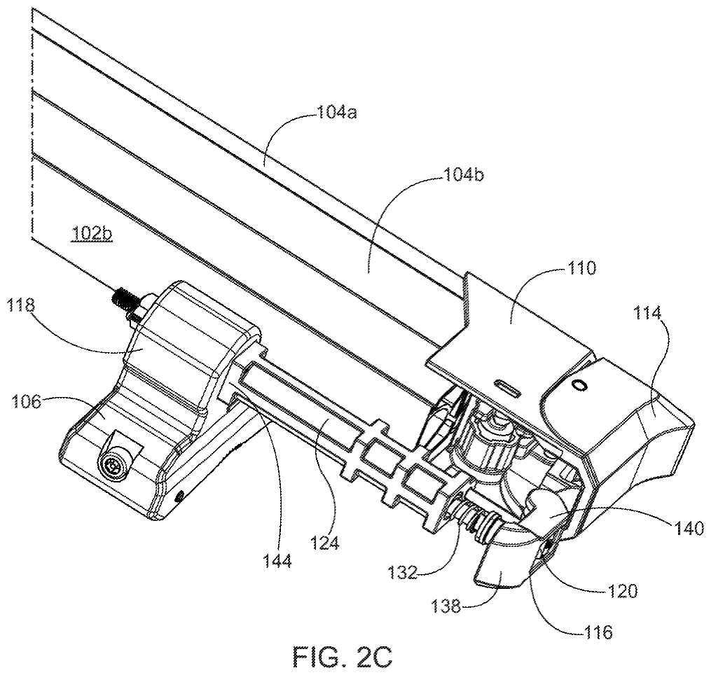

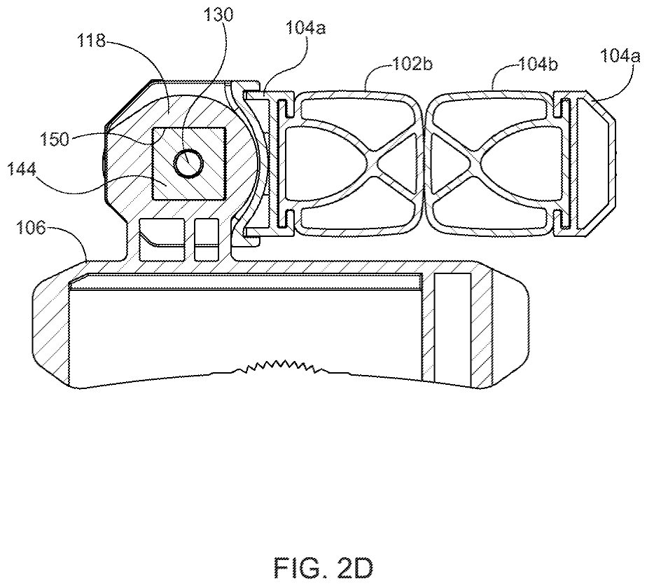

Referring now to FIGS. 2A, 2B, 2C, and 2D a detailed perspective view, a cross-sectional view, a cut-away view, and a cross-sectional view, respectively, of an embodiment of the rack assembly 100 with a positional latch system are depicted in the stowed and latched position. In this position, the actuator 116 is in the closed position. In the depicted embodiment, the actuator 116 is a lever that is pivotally attached to the rack assembly 100 at pivot 140 with a tab 138 for actuation by a user. In other embodiments, the actuator 116 may be a tab or protrusion attached to the base member 102 via a slot or groove that provides for linear movement of the actuator 116 instead of pivotal movement. The depicted embodiment shows the lever 116 pivoting from the bottom of base member 102 towards the top, but in over embodiments it may pivot from one side of the rack assembly 100 to the other. In other embodiments, the actuator 116 may be a knob, ring, or handle on the end of bolt 122, or a push button that the user depresses to release the latch mechanism. Other variations of the actuator 116 will occur to those in this art as alternatives that are within the scope of the claimed invention. This embodiment of the lever 116 has a groove or recess in its outer surface for receiving a sliding nut 120. In other embodiments the groove or recess may be a cavity within the lever 116, or accessible from the side of lever 116 and not visible from outside the device.

The actuator 116 may be connected to the other components of the latch mechanism by a variety of components. The depicted version of the device utilizes a bolt 122 with a nut 120 attached near or at first end of the bolt to connect the actuator 116 to the rest of the latch mechanism. The nut 120 is disposed in the recess on the lever 116. The recess is preferably elongated to allow the nut 120 to slide back and forth in the recess to avoid binding between bolt 122 and other components of the device as the lever 116 is pivoted to release the latch. A slot extends from the recess through the lever 116 to allow bolt 122 to connect to the latch mechanism.

In the depicted embodiment, the latching hinge or pivotal latch mechanism comprises a hinge component 118, which may also be referred to as the eye (as part of a knuckle hinge) or barrel of the hinge, and a hinge component 119, which may also be referred to as the fork (as part of a knuckle hinge) or a barrel of the hinge. The two components are pivotally attached to one another. In the depicted embodiment hinge component 118 is attached to or formed as part of the mount 106. It comprises a body having a socket 136. In a preferred embodiment the socket has a cylindrical section 148 and a locking section, or first portion, 150 shown more clearly in relation to later figures. In the depicted embodiment the locking section of the socket 136 has a square cross-section, although other cross-sectional shapes may also be used with similar effect. In the depicted embodiment, a hole extends from the end of the socket 136 through the remainder of the body of hinge component 118 to receive hinge pin 130.

In the depicted embodiment, the hinge component 119 fits over hinge component 118 as depicted, though in other embodiments it may be disposed to one side or the other of the component 118. The hinge component 119 may be fixedly attached to the base member 102 or formed as part thereof. The hinge component 119 is also preferably provided, at least in part, with an aperture that matches the cross-section of the locking portion 150 of the socket 136. It may also have a hole that extends through it to receive the hinge pin 130, and in some cases a nut may be secured or retained by the hinge component 119 to secure the hinge pin 130 in the hinge. The hinge components 118 and 119 are rotatably connected by a hinge pin 130. In some embodiments the hinge components 118 and 119 may be attached to the opposite parts of the latch mechanism, namely member 102 and mount 106, respectively.

A latching member 124, sometimes referred to as a shuttle block or shuttle member, is operated by actuator 116 to engage and disengage the hinge components 118 and 119 from one another to either allow or prevent pivotal movement of the latching hinge. In the depicted embodiment the shuttle member 124 is slidably disposed on the hinge pin 130 which extends through a hole extending lengthwise through the shuttle member 124. The shuttle member 124 may translate along the hinge pin 124. In some embodiments it may be desired to bias the shuttle member 124 to be at a certain position on hinge pin 130 or to move in a certain direction on hinge pin 130 when it is possible for it to do so. In the depicted embodiment, a compression spring 132 is disposed between shuttle member 124 and the head of hinge pin 130 or some other structural component of the mechanism. The compression spring 132 biases the shuttle member to translate toward hinge component 118 in this embodiment. In other embodiments it may be desired to bias the shuttle member 124 to move in a different direction on the hinge pin 130. In this embodiment the spring 132 is disposed within an optional socket or cavity 134 in a portion of the shuttle member 124.

At least a first portion of the shuttle member 124 comprises a locking portion, or first portion, 144 which has a cross-section that can engage the locking portion 150 of socket 136 in hinge component 118 to prevent rotational movement of the shuttle member 124 with respect to the hinge component 118. The movement of the shuttle member 124 on hinge pin 130 causing the locking portion 144 to be inserted into or withdrawn from the locking portion 150 of the socket 136, corresponds to the engaged and disengaged, or latched and unlatched states of the positional latch mechanism, respectively. In the depicted embodiment, the locking portion 144 of shuttle member 124 has a square cross-section and the locking portion 150 of socket 136 has a square cross-section, allowing the hinge to be locked in positions that are rotated 90° apart from each other. In other embodiments, the locking portions 144 and 150 may have octagonal cross-sections, or the locking portion 144 may have a square cross-section and the locking portion 148 may have an octagonal star cross-section, allowing locked positions that are rotated 45° apart from each other.

Any other combination of cross-sectional shapes 144 and 150 that will allow the locking portion 144 of the shuttle member 124 to be inserted into the locking portion 150 of socket 136 to prevent rotation of the hinge at certain desired positions may be used in other embodiments. Another example of a shuttle and socket may be described as having interlocking teeth on the surface of the locking portions thereof. In these embodiments the locking portion 144 of the shuttle member 124 may have one or more teeth or protrusions extending outwardly from the shuttle member, and the locking portion 150 of the socket 136 may have one or more cavities, apertures, or notches for receiving the tooth in a desired pivotal position. Conversely the tooth or protrusion may extend inwardly from the surface of the socket and the shuttle member may be provided with a cavity for receiving the tooth. In some of these embodiments, the locking portions of the shuttle member and socket may be provided with interlocking teeth or protrusions around the entire circumference thereof. When such teeth are disposed around a circular central shaft the shuttle member 124 may be retained with respect to the hinge component 118 at each interlocking position of the two components.

Additional non-circular cross-sectional shapes may be selected for the locking portion 144 of the shuttle member 124 and the locking portion 148 of socket 136. In some embodiments, the cross-section of the first portion 144 and cross-section of the first portion 150 are congruent. In some cases, the shuttle member 124 is provided with a socket for receiving a protrusion on the hinge member 118, effectively switching the features shown on the shuttle member 124 to the hinge component 118, and vice versa.

The shuttle member 124 rotates in coordination with the base member 102 and may be maintained in that regard by structural components of base member 102 in some embodiments. In a preferred embodiment, a portion of shuttle member 124 extends through aperture 152 in hinge component 119. In the depicted embodiment, aperture 152 has a cross sectional shape that allows the shuttle member 124 to slide through the aperture 152 so that it can engage and disengage from the hinge component 118 but does not allow it to rotate within the aperture 152. Thus, in this design hinge component 119 and base member 102 are only able to pivot with respect to the hinge component 118 and mount 106 when the shuttle member 124 is able to pivot with respect to hinge component 118. As a result the engaging or disengaging of the locking portion 144 of the shuttle member 124 from the locking portion 150 of the hinge component 118, prevents or allows the pivoting of the hinge and reconfiguration of the rack assembly 100 from stowed to operational positions and vice versa.

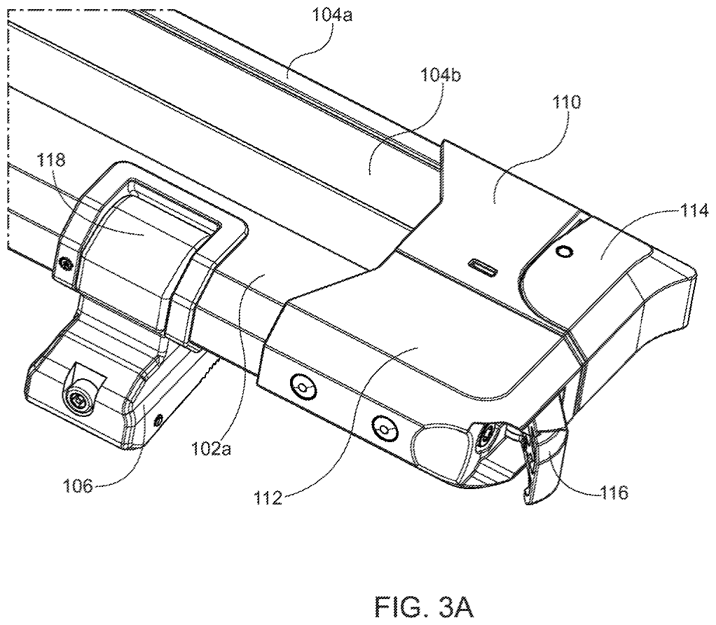

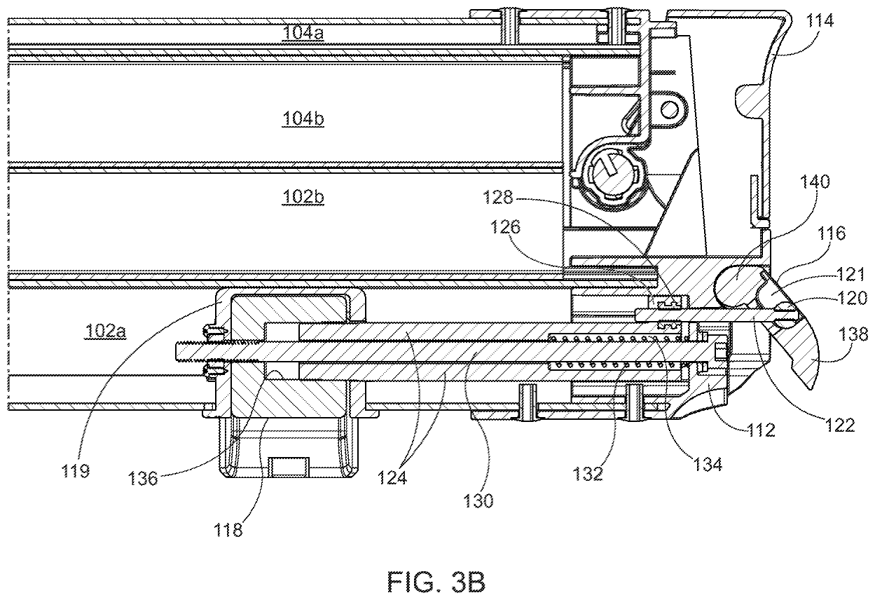

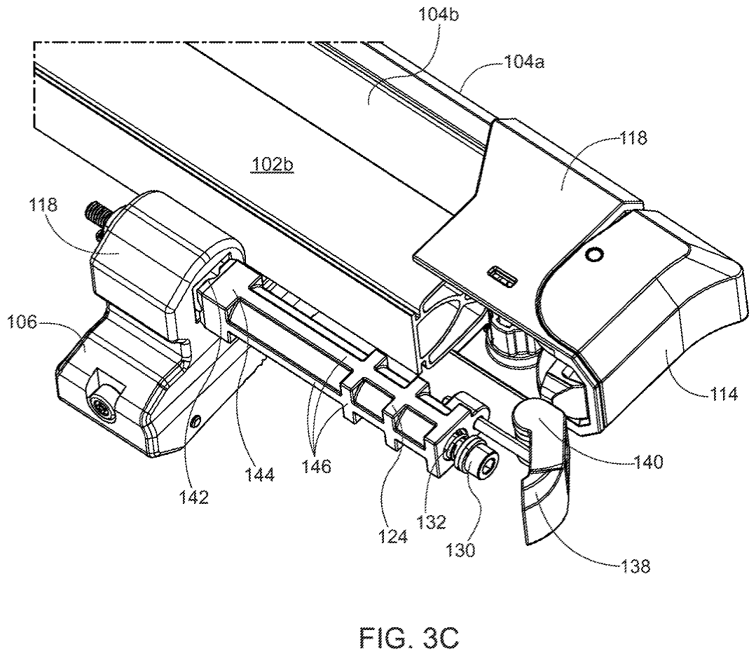

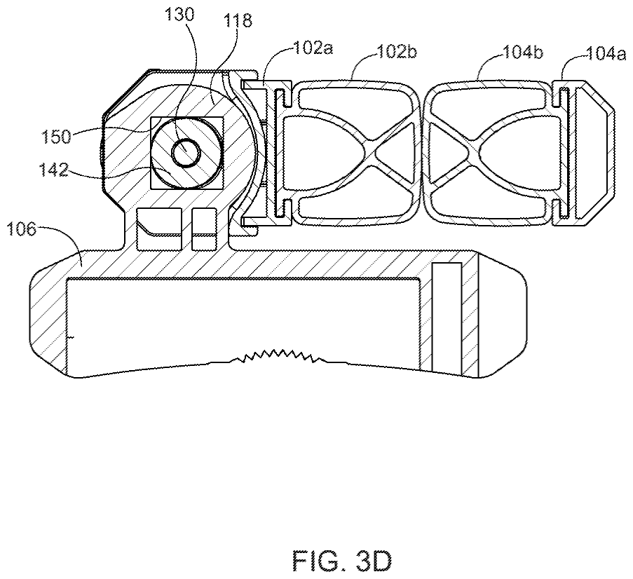

The actuator 116 is connected to the shuttle member 124 so that a user may cause the shuttle member to retract or disengage from the hinge component 118 by manipulation of the actuator 118. In the depicted embodiment, the bolt 122 is threaded into a nut 128 that is embedded in a socket 126 that is part of shuttle member 124. Thus when a user pivots the lever 116 as shown in FIGS. 3A-3D, the bolt 122 exerts a force on shuttle member 124 disengaging it from hinge component 118 and also compressing spring 132. The rack assembly 100 may then be pivoted with respect to the mounts 106 to pivot it from the stowed to operational positions, and vice versa. In this embodiment, when the locking portion 144 next aligns with the locking portion 150 of socket 136 the force of spring 132 may cause the shuttle member 124 to engage the hinge component 118 again and latch the hinge and rack in place.

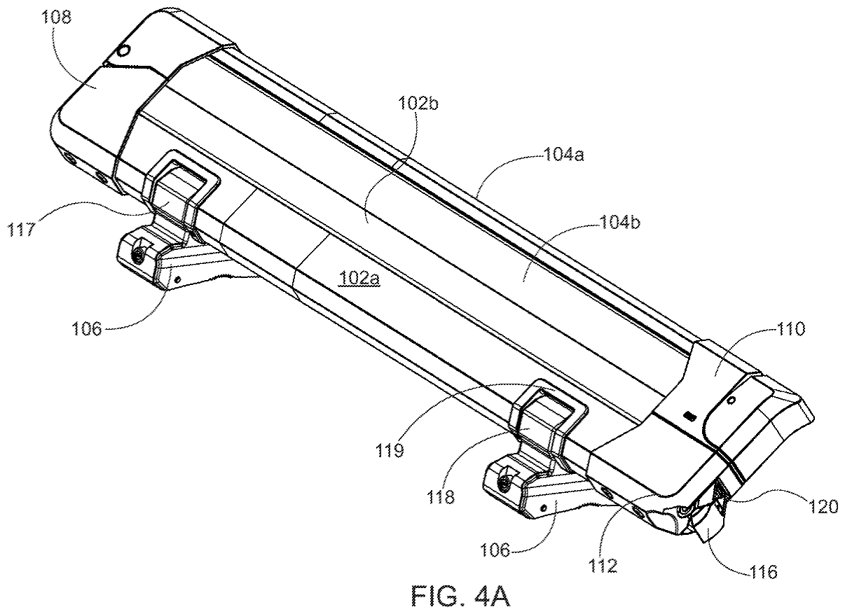

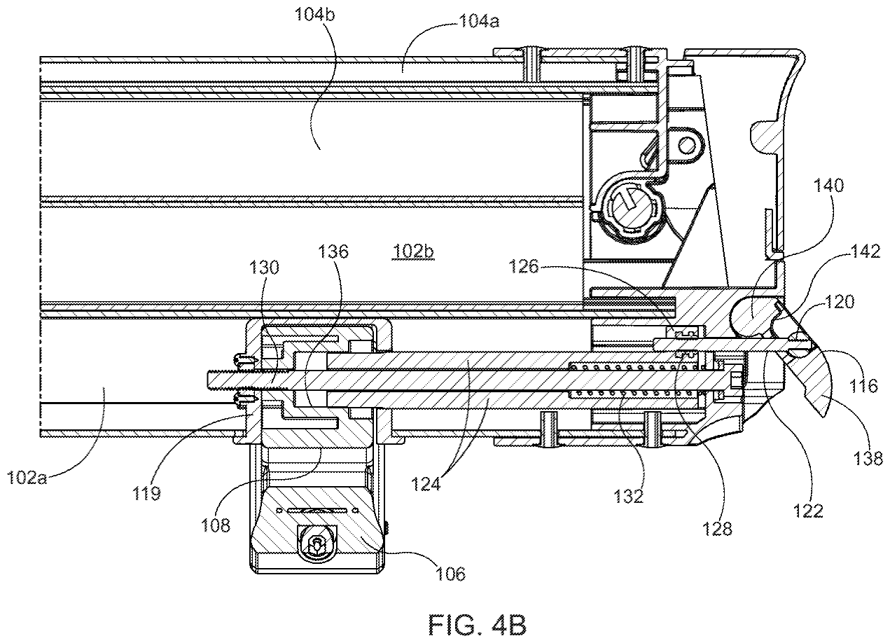

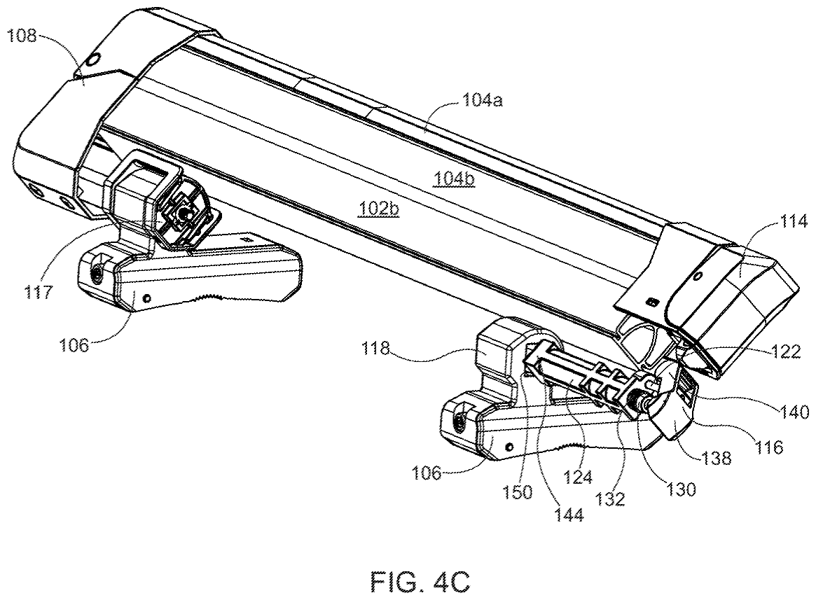

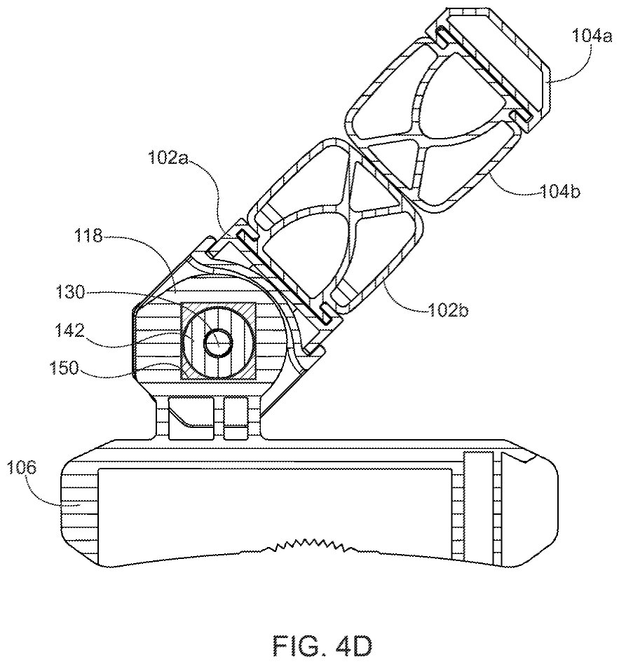

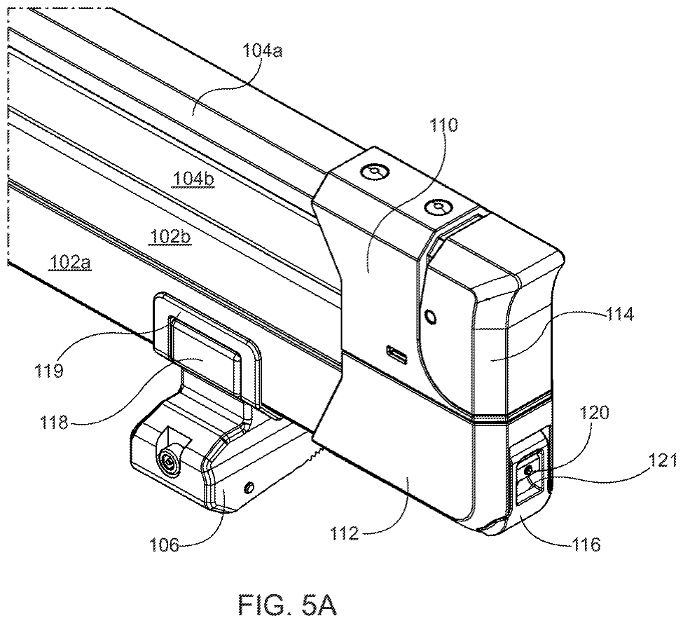

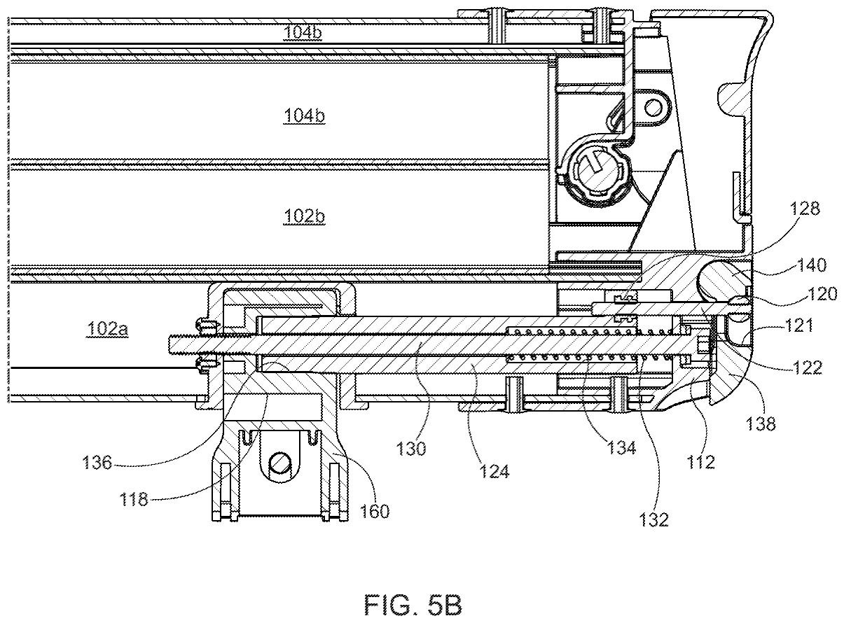

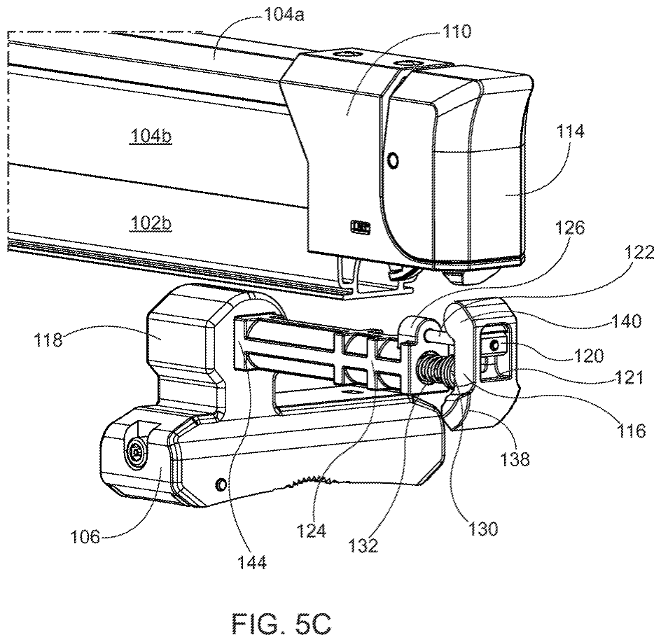

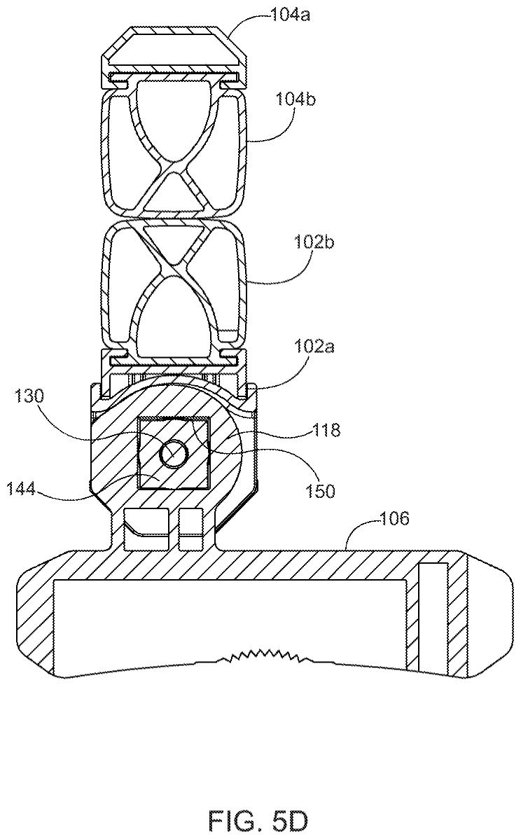

The FIGS. 2A-5D depict various views of an embodiment of the rack assembly 100 in a progression from the stowed and latched position to the operational and latched position. FIGS. 2A-2D depict the stowed and latched figuration. FIGS. 3A-3D represent the stowed and unlatched position. FIGS. 4A-4D depict the rack in a partially pivoted position. FIGS. 5A-5D show the rack in the operational and latched position. These views are exemplary of a preferred embodiment of the inventive device, but do not limit the scope of the claims to that embodiment only.

Referring now to FIGS. 2A-2D, the lever 116 is shown in a closed position, flush with the surface of base member 102. The shuttle member 124 is engaged in the locking portion 150 of the socket 136 in hinge component 118. In this embodiment, the shuttle member 124 further comprises a cylindrical portion 142 on the end of the shuttle member 124 that is disposed in a cylindrical portion 148 of socket 136. The cylindrical portion 142 may provide additional support to the shuttle member 124 and hinge component 118 when the shuttle member 124 is in the disengaged position shown in later figures.

FIGS. 3A-3D show the embodiment in a stowed and unlatched position. The tab 138 of release lever 116 is pivoted away from base member 102 causing the bolt 122 to pull shuttle member 124 out of engagement with the hinge component 118. The cylindrical portion 142 of the shuttle member 124 is still disposed inside the socket 136 but that does not prevent rotation of the hinge components. The spring 132 is compressed by the shuttle member 124 and exerts a force on the shuttle member 124 that tends to engage it with hinge component 118.

FIGS. 4A-4D depict the rack assembly 100 with members 102 and 104 partially pivoted between the stowed position and the operational position. The cross-sectional and cut-away views clearly show that the locking portion of the shuttle member 124 has been withdrawn from the locking portion of the socket 136 to allow the shuttle member 124 to rotate with respect to the hinge component 118.

FIGS. 5A-5D depict the rack assembly 100 in the operational position ready to receive equipment such as skis or snowboards. The continued rotation of the base member 102 from the position shown in FIGS. 4A-4D has brought the locking portion 144 of the shuttle member 124 into alignment with the locking portion 150 of socket 136. The force exerted by spring 132 has caused the shuttle member 124 to move into the socket 136 and the latch to engage, preventing further rotation without additional actuation of the lever 116.

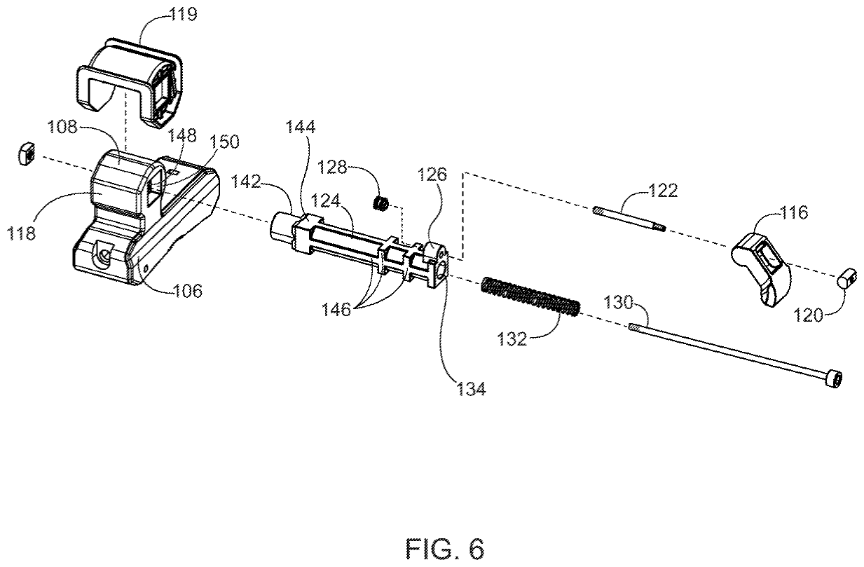

FIG. 6 depicts an exploded view of the components of this embodiment of the positional latch mechanism. Hinge component 118 is shown as optionally formed as a part of mount body 106. The hinge pin 130 extends through spring 132 and shuttle member 124 and is secured by a nut on the opposing side of hinge component 119. Nut 128 is embedded in socket 126 and receives one end of bolt 122. The opposing end of bolt 122 is attached to the sliding nut 120 positioned in the recess in lever 116. The depicted shuttle member has ribs or runners 146 that may be used to provide support for the shuttle member 124 in relation to other components of base member 102.

In other embodiments of the inventive device, the shuttle member 124 may extend through the hinge component 118 so that the locking portion of shuttle member 124 is on the opposing side of the hinge. In such embodiments a user might press on the shuttle member 124 to release the positional latch mechanism.

In other embodiments, the actuator 116, and connecting components like sliding nut 120 and bolt 122, may not be included, and shuttle member 124, or some portion of it, may be accessible to a user to move as necessary to release the positional latch mechanism.

In other embodiments, the hinge component 118 may be attached to base member 102, and the shuttle member 124 disposed in another component such as mount body 106.

In other embodiments, the shuttle member 124 may be offset from the axis of the hinge and hinge pin 130 and may engage features on the outer surface of the hinge component 118, such as grooves, protrusions, or apertures therein.

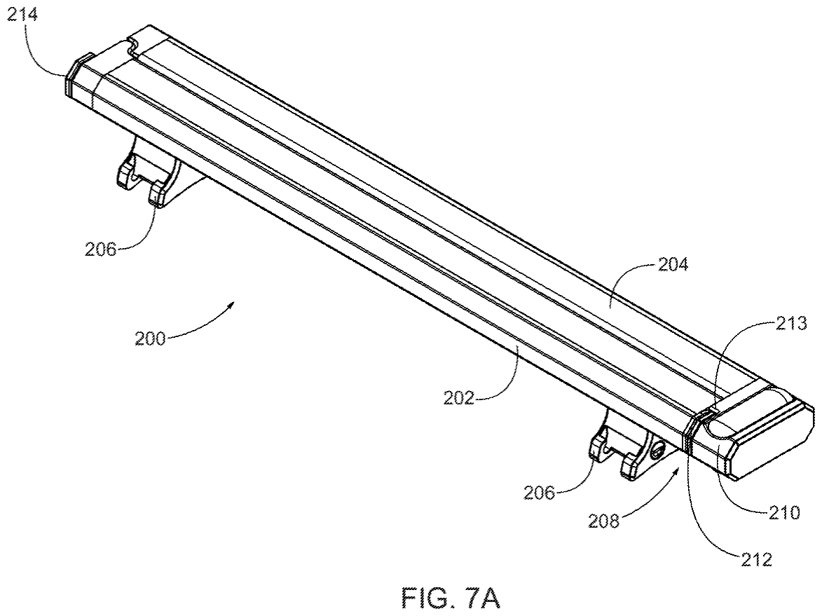

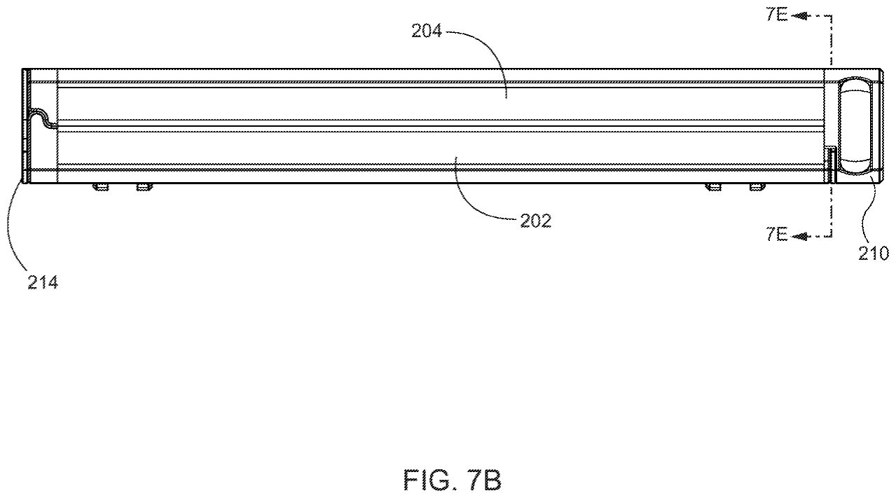

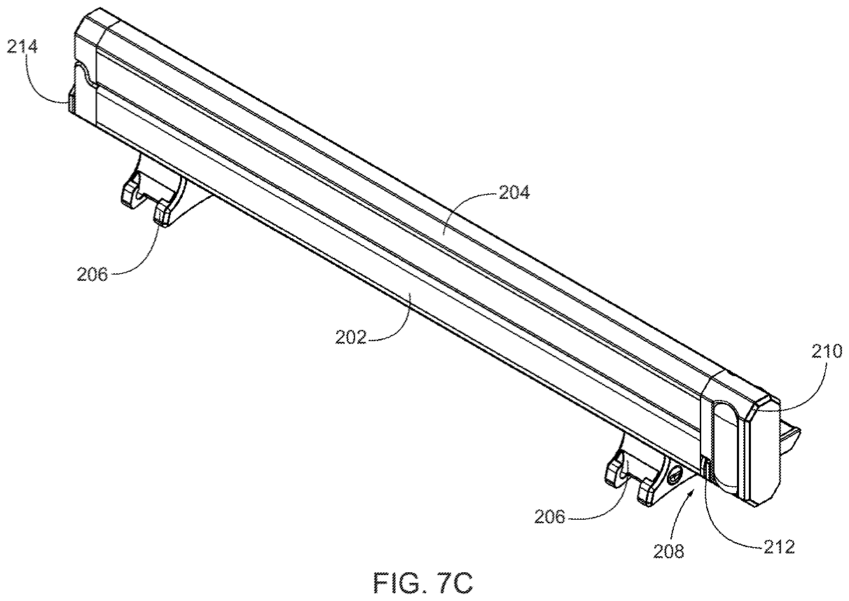

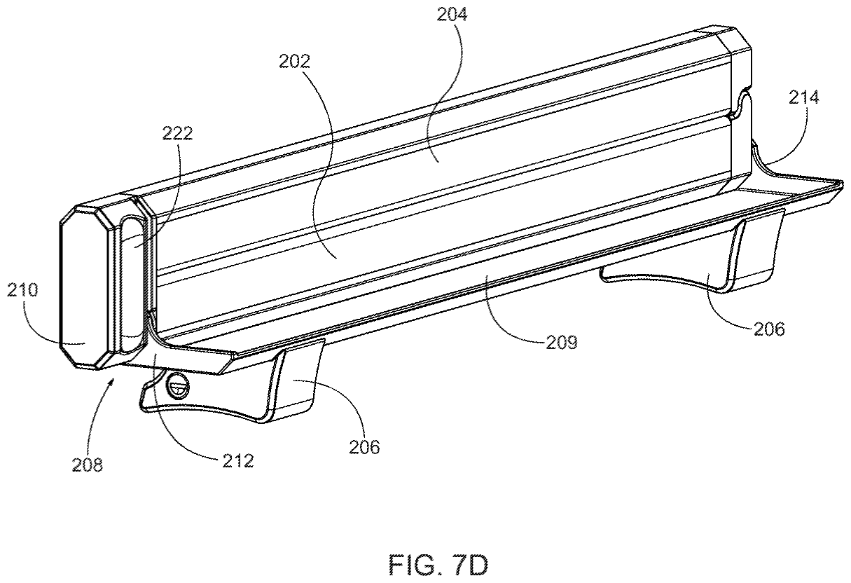

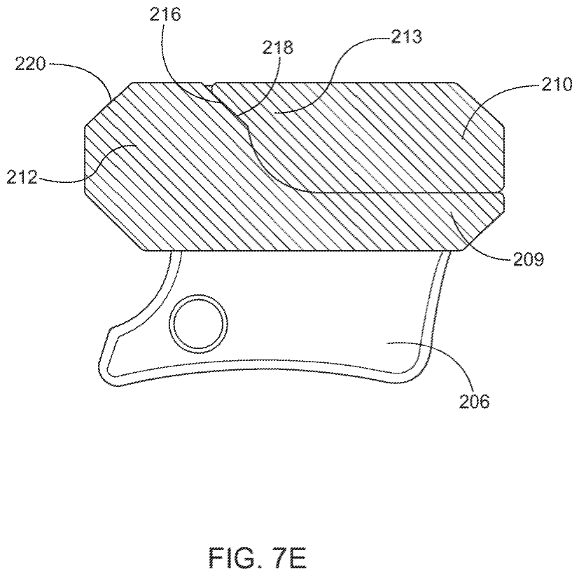

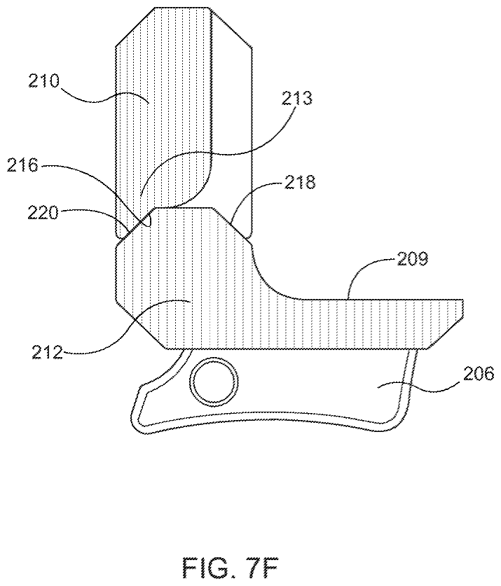

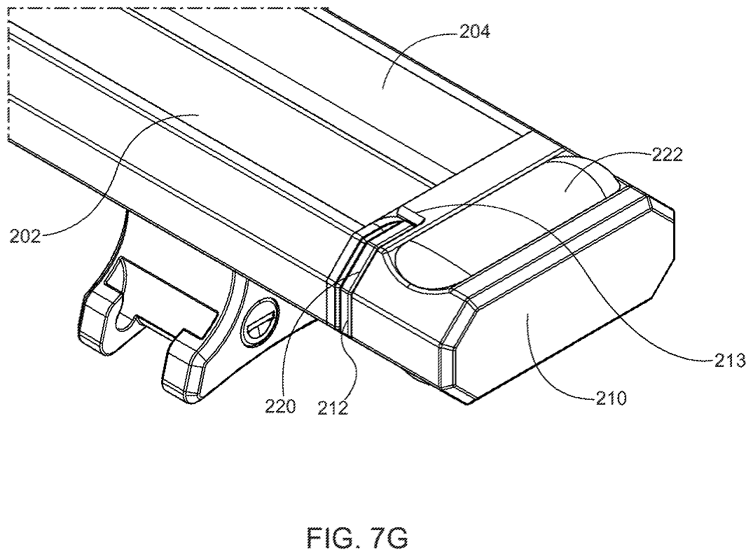

An additional embodiment of the inventive device is depicted in FIG. 7A-7F. This embodiment comprises a rack 200 with a base member 202 and a clamp member 204. The rack 200 may be connected to a vehicle by one or more mounts 206 that may be integrated into or formed as part of rack 200 or may be removeable from rack 200. A clamp release 222 may be provided to allow the clamp member 204 to be moved or pivoted away from the base member 202 to load or unload equipment from the rack 200. The FIGS. 7A, 7B, 7E, and 7G depict the rack 200 in a stowed position as described for the prior embodiment. FIGS. 7C, 7D, and 7F depict the rack 200 in an operational position.

In the additional embodiment in FIGS. 7A-7G, the positional latch mechanism does not require an actuator to release the latch. This mechanism relies on the friction and interaction between hinge component 210 and hinge component 212. In the depicted embodiment the latch mechanism is near one end of the rack 200 with a non-latching hinge 214 at the other end. In varying embodiments, there may be a plurality of latching hinges or pivotal latch mechanisms 208 at points along the length or at the other end of base member 202. In this embodiment a structural member 209 extends substantially along the length of the rack 200 to connect the mounts 206 and the pivotal latch mechanism 208. In other embodiments, the member 209 may not be present and the pivotal latch mechanism 208 may be attached directly to a mount 206.

In this embodiment, the base member 202 is pivotally mounted on the structural member 209, such as by a pin or bolt (not shown) extending from hinge components 212 and 214 into either end of the base member 202. The hinge component 212 in this embodiment extends upwardly from and is attached to or part of the member 209. The hinge component 212 is provided with one or more surfaces 218 and 220. A hinge component 213 is attached to or formed as part of member 210, base member 202, clamp member 204, or another portion of the rack 200 that pivots when the rack moves from the stowed to the operational position. The hinge component 213 has at least one surface 216 that is shaped to interact with the surfaces 218 and 220 on hinge component 213.

When the rack 200 is in the stowed position the surface 216 is adjacent to the surface 218. This is most clearly shown in FIG. 7E depicting a cross-sectional view along the axis 7-7 shown on FIG. 7B. In the depicted embodiment the element 210 of rack 200 incorporates the hinge component 213 with surface 216 approximately adjacent to surface 218 of hinge component 212. Either or both of the hinge components 212 and 213, or a portion of each, may be formed from a resilient or elastic material. The interaction between these two surfaces 216 and 218 resists the rotation of rack 200 with respect to the hinge component 212 through friction between the surfaces and the potential need for deformation, such as compression or bending, of the components 212 or 213 to allow rotation of the rack 200. Typical forces exerted on the rack 200 by road forces or movement of a vehicle to which the rack 200 is attached will not be sufficient to overcome friction and cause necessary deformation, if any. However, when a user applies a force to the rack 200 to cause it to pivot toward the operational position, the force may be sufficient to deform either components 212 or 213 or both, and to overcome any frictional resistance to pivoting, thus allowing the rack 200 to pivot.

Similarly, when the rack 200 is in the operational position the surface 216 of hinge component 213 is adjacent to and interacts with surface 220 of hinge component 212. This is shown most clearly by the cross-sectional view of FIG. 7F. As can be seen in FIG. 7G, the surface 216 may be formed as part of member 210, though it may also be formed or attached to another component such as base member 202, or as a separate component itself.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. An equipment rack for use with a vehicle, the rack comprising:
a rack assembly;
a hinge for pivotally attaching the rack assembly to a vehicle;
wherein the rack assembly is configured to pivot with respect to the hinge from a stowed position to an operational position;
a positional latch mechanism configured to selectively retain the rack assembly in a desired position.

2. The equipment rack of claim 1 wherein actuating the positional latch mechanism releases the rack assembly from the stowed position.

3. The equipment rack of claim 1 wherein the positional latch mechanism further comprises a first feature attached to the rack assembly configured to selectively engage a second feature attached to the hinge.

4. The equipment rack of claim 3 wherein one of the features comprises a shuttle member slidably attached to the rack assembly or the hinge.

5. The equipment rack of claim 4 wherein the other feature comprises a socket capable of receiving the shuttle member.

6. The equipment rack of claim 5 wherein the rack assembly cannot pivot with respect to the hinge when the shuttle member is disposed in the socket.

7. The equipment rack of claim 6 wherein the socket has a cross-sectional shape that receives the shuttle member at a pivotal position corresponding to the stowed position of the rack assembly.

8. The equipment rack of claim 6 wherein the socket has a cross-sectional shape that receives the shuttle member at a pivotal position corresponding to the operational position of the rack assembly.

9. The equipment rack of claim 6 wherein the socket has a cross-sectional shape that receives the shuttle member at a first pivotal position corresponding to the stowed position of the rack assembly and at a second pivotal position corresponding to the operational position of the rack assembly.

10. The equipment rack of claim 5 wherein at least a first portion of the shuttle member has a non-circular cross-sectional shape, and at least a first portion of the socket has a cross-sectional shape capable of receiving the first portion of the shuttle member, wherein when the first portion of the shuttle member is received by the first portion of the socket the shuttle member is pivotally fixed with respect to the hinge.

11. The equipment rack of claim 10 wherein when the first portion of the shuttle member is withdrawn from the first portion of the socket then the shuttle member may pivot with respect to the hinge.

12. The equipment rack of claim 10 wherein the cross-sectional shape of the socket is congruent to the cross-sectional shape of the shuttle member.

13. The equipment rack of claim 10 wherein the socket is capable of receiving the shuttle member at a plurality of pivotal positions.

14. The equipment rack of claim 6 further comprising a biasing mechanism to urge the shuttle member into the socket of the hinge.

15. The equipment rack of claim 14 further comprising an actuator to withdraw the shuttle member from the socket of the hinge.

16. The equipment rack of claim 3 wherein the first feature attached to the rack assembly comprises a first surface, and the second feature attached to the hinge assembly comprises a second surface attached to the hinge, wherein the first surface interacts with the second surface to resist rotation of the rack assembly from the stowed position or the operational position.

17. The equipment rack of claim 16 wherein the rack assembly pivots from the stowed position to the operational position when the interaction of the first surface with the second surface is overcome by a rotational force applied to the rack assembly.

18. The equipment rack of claim 17 wherein the applied rotational force causes elastic deformation of the first surface or the second surface to pivot the rack assembly from one desired position to another desired position.

19. The equipment rack of claim 17 wherein the applied rotational force overcomes frictional resistance to pivot the rack assembly from one desired position to another desired position.

20. The equipment rack of claim 16 further comprising a third surface attached to the hinge, wherein the third surface interacts with the first surface to resist rotation of the rack assembly from a desired pivotal position of the rack assembly.

21. The equipment rack of claim 20 wherein the first surface, the second surface, and the third surface are substantially tangential to the pivotal axis of the rack assembly and the hinge.

22. The equipment rack of claim 5 wherein the shuttle member further comprises at least one tooth and the socket further comprises at least one cavity capable of receiving the at least one tooth when the shuttle member is in a desired position.
